(19) United States
(12) Patent Application Publication
(10) Pub. No.: US 2003/0093626 A1
(43) Pub. Date: May 15, 2003

(54) Memory caching scheme in a distributed-memory network

(76) Inventor: James D.M. Fister, Tigard, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/000,872

(22) Filed: Nov. 14, 2001

(51) Int. Cl. G06F 13/00

(52) U.S. Cl. 711/147

(57) ABSTRACT

A structure having a plurality of systems interconnected within a network. The structure includes a distributed memory to provide for use of a local memory by enabling memory mapping of the system addresses to distributed memory, and a network processor to control and execute the memory mapping. The structure also includes a cache to store data frequently used within the distributed memory but not stored in the local memory.

### BACKGROUND

The present invention relates to a distributed-memory system. More particularly, the present invention relates to memory caching scheme in such a distributed-memory network.

An Internet Protocol (IP) address may be assigned to each host system or device operating within Transmission Control Protocol/Internet Protocol (TCP/IP) network. The IP address includes a network address portion and a host address portion. The network address portion identifies a network within which the system resides, and the host address portion uniquely identifies the system in that network. The combination of network address and host address is unique, so that no two systems have the same IP address.

Accordingly, a distributed memory network enables memory space expansion by memory mapping network address space such as Internet Protocol (IP) addresses into a local system memory design. Allowing system applications to have access to the memory-mapped network address space enables enhanced interaction between systems. An example distributed memory network is described in commonly-owned, U.S. patent application Ser. No. 09/967,634 (filed Sep. 26, 2001), entitled “Memory Expansion and Enhanced System Interaction using Network-distributed Memory Mapping”, by Fister, et al. In such a distributed memory network, IP addresses are translated directly from a local system memory. However, the wait time associated with access of this type may be substantially longer than wait times associated with typical memory access or even hard disk access.

### BRIEF DESCRIPTION OF THE DRAWINGS

FIG. 1 illustrates a distributed network configured. with a plurality of systems interconnected by a network interface according to an embodiment of the present invention.

FIG. 2 is a block diagram of a network facilitator including a distributed memory network in accordance with an embodiment of the present invention.

FIGS. 3A to 3D illustrate a technique executed on a centralized system for caching data used in the distributed memory network according to an embodiment of the present invention.

FIGS. 4 and 5 illustrate a technique executed on a satellite system for caching data used in the distributed memory network according to embodiments of the present invention.

FIG. 6 is a block diagram of a processor-based system that may execute codes related to the technique for caching data used in a distributed memory network described in FIGS. 3A through 5.

### DETAILED DESCRIPTION

In recognition of the above-stated difficulties with prior designs of memory access in a distributed memory network, the present invention describes embodiments for providing a memory-caching scheme in such a distributed memory network. Furthermore, peer-to-peer connection is provided for data validation. Consequently, for purposes of illustration and not for purposes of limitation, the exemplary embodiments of the invention are described in a manner consistent with such use, though clearly the invention is not so limited.

A network system coupled to the memory bus of the processor/chipset that maps network address space, such as Internet Protocol (IP) addresses, as local memory is disclosed. This network system encompasses the concept of mapping network address space as memory so that the system may treat even remote local area network (LAN) and wide area network (WAN) addresses as local memory addresses. Software implementation of the memory mapping involves a local memory look-up table that would redirect memory requests to a network address (e.g. an IP address) on the network. Further, memory mapping of the IP addresses may include capabilities to handle not only 32-bit addressing provided by Internet Protocol Version 4 (IPv4) but also 128-bit addressing provided by Internet Protocol Version 6 (IPv6). Therefore, the memory mapping enables mapping of IP addresses assigned to devices as diverse as mobile telephones, other communication devices, and even processors in automobiles.

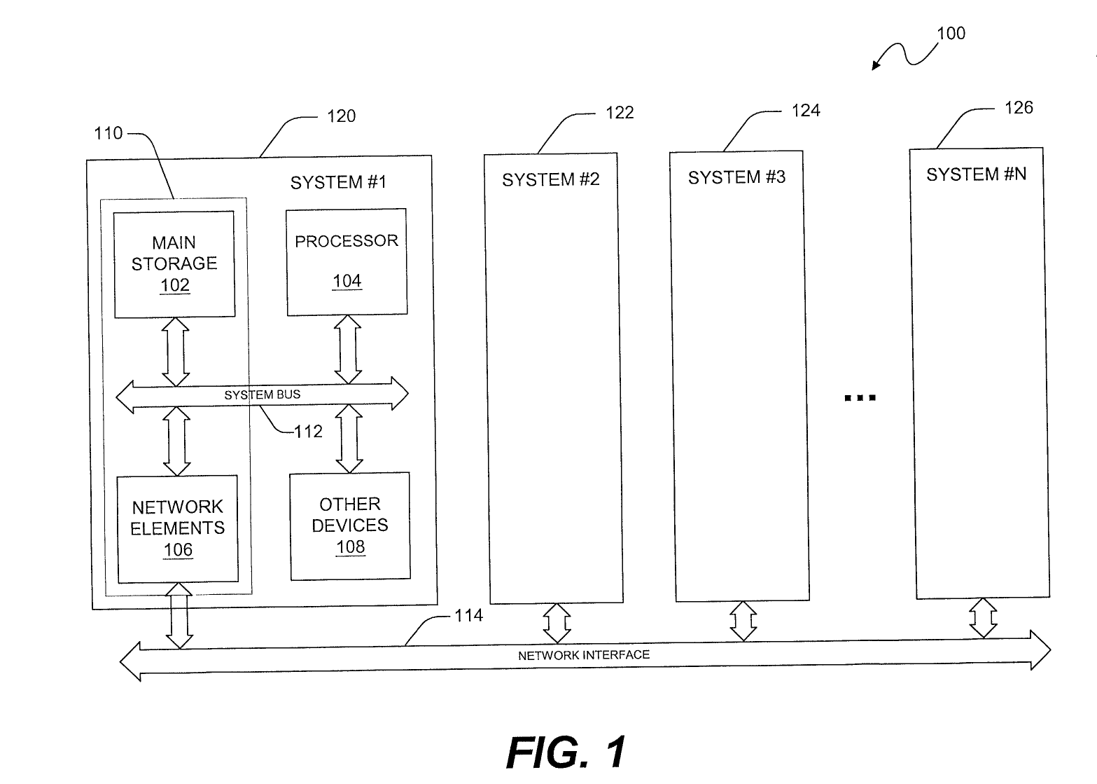

FIG. 1 illustrates a distributed network 100 configured with a plurality of systems 120, 122, 124, 126 interconnected by a network interface 114 according to an embodiment of the present invention. The network interface 114 may include devices, circuits, and protocols that enable data communication between systems 120, 122, 124, 126. For example, the network interface 114 may include modems, fiber optic cables, cable lines, Digital Subscriber Line (DSL), phone lines, Transmission Control Protocol/Internet Protocol (TCP/IP), and other related devices and protocols. In some embodiments, systems 120, 122, 124, 126 may be configured as computer systems. Thus, systems 120, 122, 124, 126 may be substantially similar in configuration and functions.

In the illustrated embodiment, the system 120 includes a processor 104 for executing programs, a main storage 102 for storing programs and data during program execution, other devices 108 such as a display monitor or a disk drive, and network elements 106 for controlling data transfer to and from the network interface 114. In one embodiment, the main storage 102 may be configured as a non-volatile memory, and may include programs and look-up tables to enable memory mapping of the network address space. The network elements 106 may include blocks such as a network processor, a network cache, and/or network adapter. The main storage 102 and the network elements 106 may be combined to constitute a network facilitator 110. Each system 120, 122, 124, 126 also includes a system bus 112 used as a data transfer path between blocks 102, 104, 106, 108.

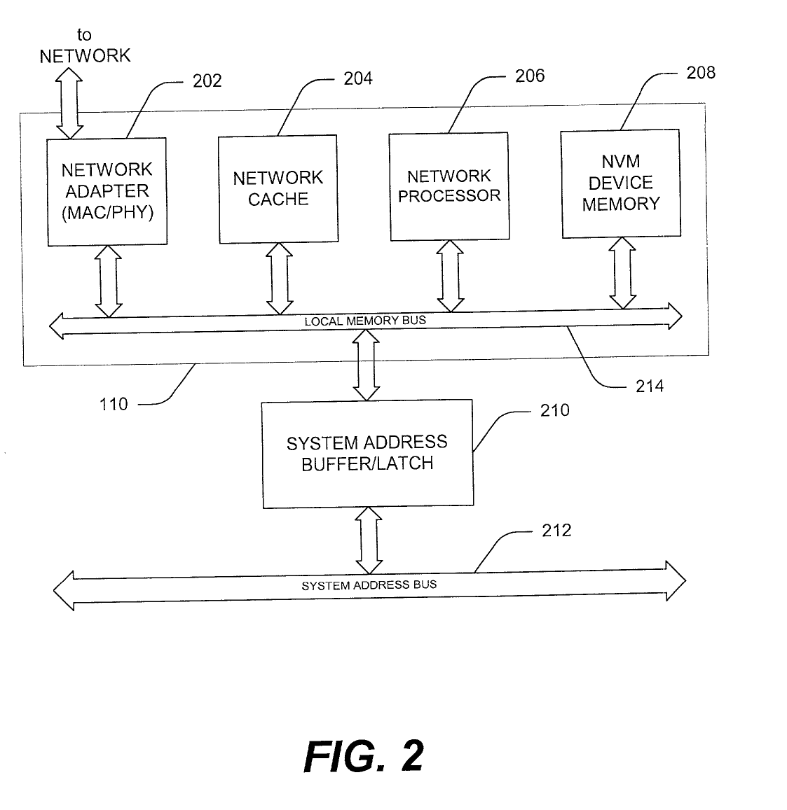

A block diagram of a network facilitator 110 including a distributed memory network in accordance with an embodiment of the present invention is shown in FIG. 2. The diagram also includes a system address buffer/latch 210, which interconnects system address bus 212 with the network facilitator 110.

The system address buffer/latch 210 connects to a local memory bus 214 in the network facilitator 110. Moreover, the local memory bus 214 also interconnects blocks 202, 204, 206, 208 in the network facilitator 110. Accordingly, the network facilitator 110 further includes a network adapter 202 such as a media access control/physical layer device (MAC/PHY), a network cache 204, a network processor 206, and a non-volatile device memory (NVM) 208.

In the illustrated embodiment, the network processor 206 provides management of network configuration, data packaging, and network addressing. Furthermore, the network processor 206 controls and executes memory mapping of network address space. The network adapter 202 manages and provides access to the network. In particular, the network adapter 202 may provide high-speed networking applications including Ethernet switches, backbones, and network convergence. The non-volatile device memory 208 includes programs and a lookup table to enable memory mapping of the IP addresses. The look-up table includes entries whose parameters map IP addresses to the local memory so that a particular application on the system may directly interact with an application or applications of the system at the designated IP address. Hence, interaction between systems becomes transparent to the applications involved. To a particular application, interaction between system applications across a network or networks may operate substantially similar to interaction between different applications in the same system.

The network cache 204, whose operation is described in detail below, stores frequently used network data locally for faster access to the data in the network. The cache 204 enables this fast access by storing the most recently used data from the memory-mapped network addresses. As the network processor 206 processes data, the processor 206 searches first in the local cache memory 204. If the processor 206 finds the data in the cache 204, the processor 206 may use the data in the cache 204 rather than requesting the data from the network address designated in the look-up table.

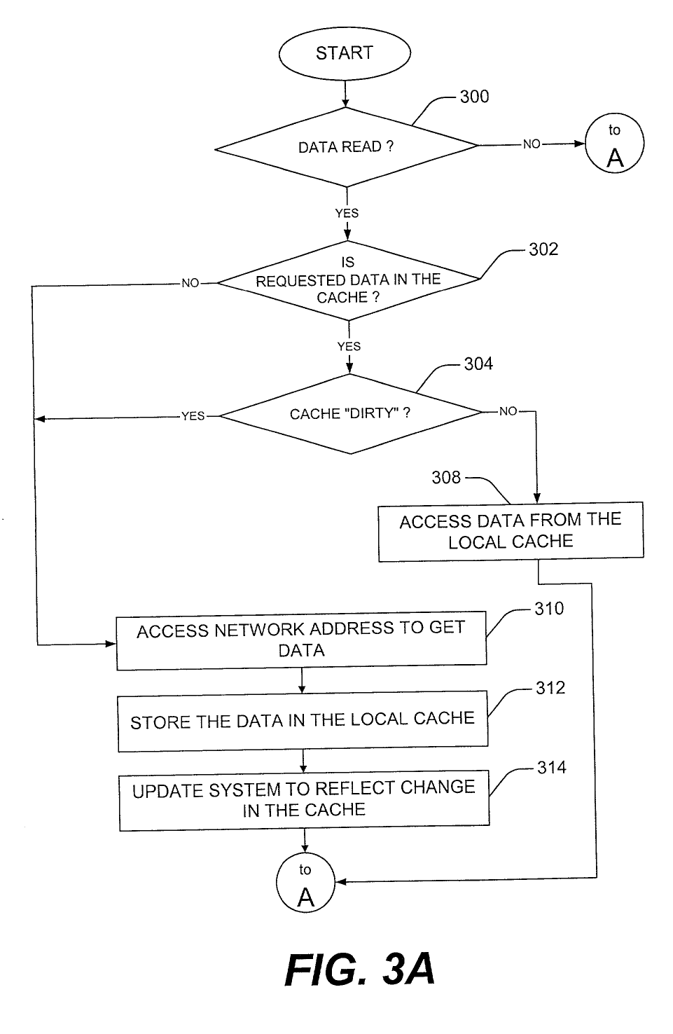

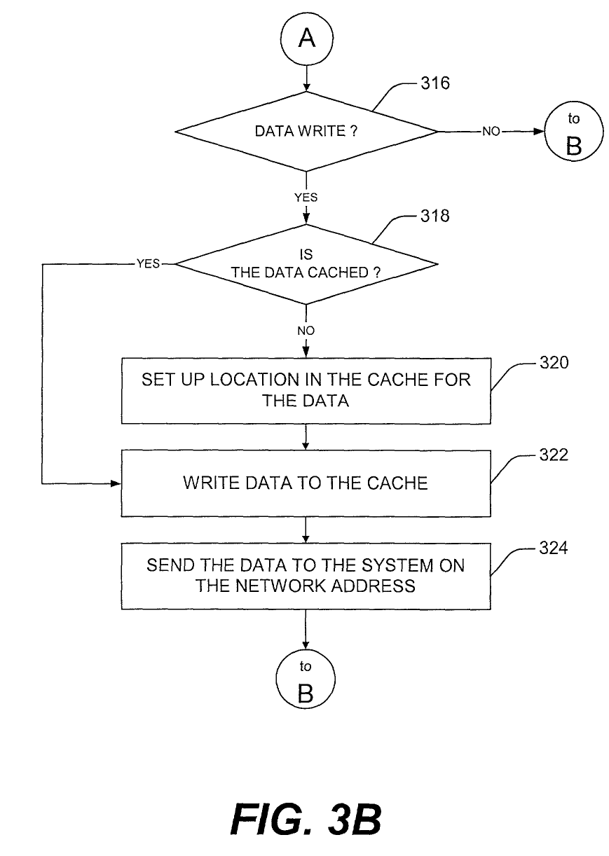

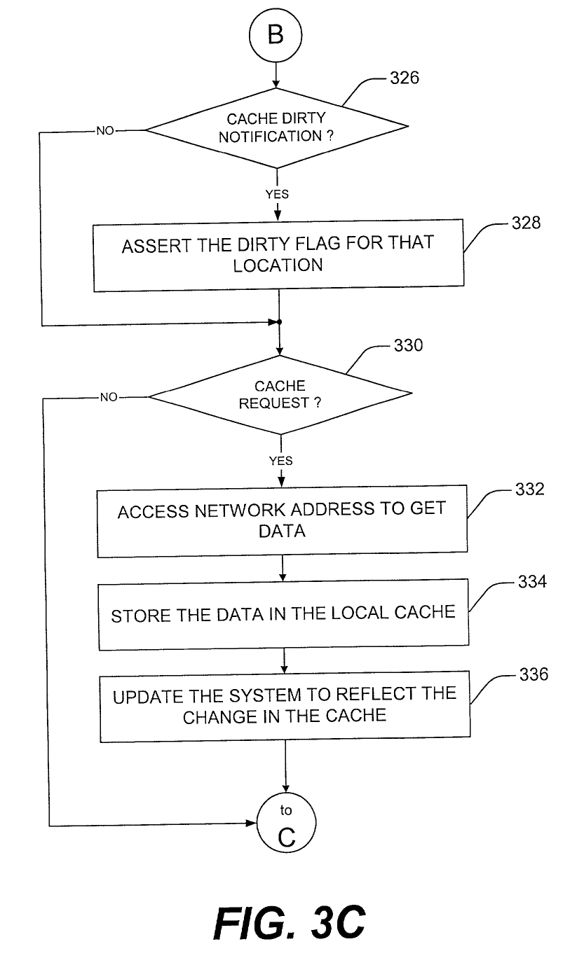

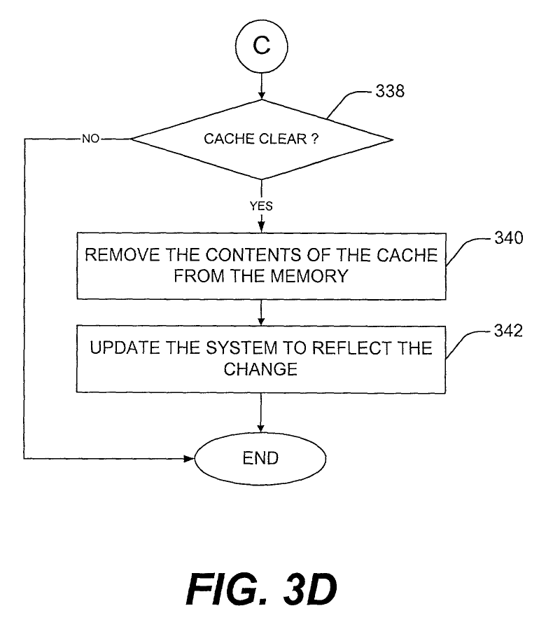

A technique for caching data used in the distributed memory network according to an embodiment of the present invention is illustrated in FIGS. 3A to 3D. The illustrated technique is executed on the centralized system that runs the application. In particular, the technique may run as a message loop or queue internal to operating system or application. Moreover, peer-to-peer connections are established between the centralized system and the satellite systems.

The technique includes examining the message queue to determine whether the queue contains a DATA READ command, at 300. If the DATA READ command is found on the queue, the local cache 204 is searched to determine if the requested data is in the cache 204, at 302. If it is determined that the requested data is in the local cache 204, a cache “dirty” flag is checked at 304. If the flag is not asserted, the current data in the local cache 204 is valid, and therefore the data may be obtained from the cache 204, at 308.

Otherwise, if the cache “dirty” flag is asserted, the current data in the local cache 204 is invalid and stale because the original data in the satellite system has been updated since the data was last cached in the local cache 204. Thus, in this case, the requested data is obtained from the system at the network address, at 310. Otherwise, if it is determined (at 302) that the requested data is not in the local cache 204, the network address is accessed (at 310) to get the data. At 312, this data is stored in the local cache. The system is then updated, at 314, to reflect the change in the cache.

At 316, the message queue is examined to determine whether the queue contains a DATA WRITE command. If the DATA WRITE command is found on the queue, the local cache 204 is searched to determine if the data is cached, at 318. If it is determined that the data is not cached in the local cache 204, a location is set up in the cache 204 for the data, at 320. Otherwise, if the data is cached in the local cache 204, the data is written to the cache 204, at 322. Furthermore, the data is sent to the system on the network address, at 324. In an alternative embodiment, instead of sending the data directly to the system on the network address, the data may be directed to another routine. This routine may determine when and how to send the data to the network address based on network traffic and/or other network/system considerations.

The message queue is examined, at 326, to determine whether the queue contains a CACHE DIRTY notification. This notification arrives as a peer notification from the satellite system. In some embodiments, multiple input disclosure procedures may be used to provide this peer notification. If the CACHE DIRTY notification is found on the queue because data on the satellite system has changed, the cache dirty flag is asserted, at 328, for that memory location.

At 330, the message queue is examined again to determine whether the queue contains a CACHE REQUEST message. If the CACHE REQUEST message is present, the network address is accessed to get the data, at 332. The data is then stored in the local cache 204, at 334. At 336, the system is updated to reflect the change in the local cache 204.

Finally, at 338, the message queue is examined to determine whether the queue contains a CACHE CLEAR message. If the CACHE CLEAR message is present, the contents of the cache are removed from the memory, at 340. The change is then updated in the system, at 342.

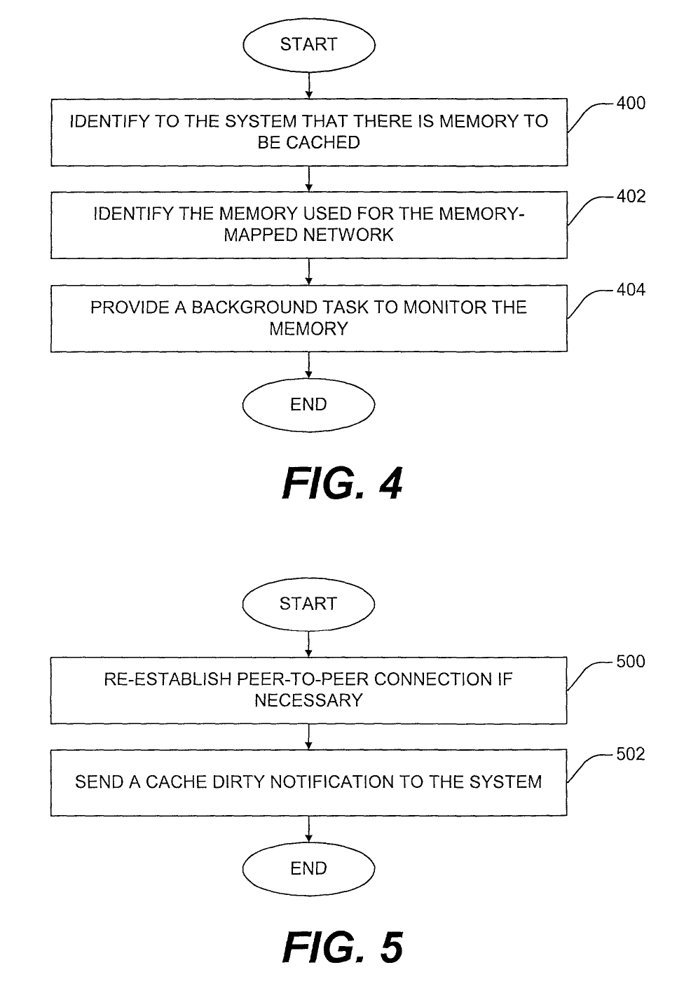

Further techniques for caching data used in the distributed memory network according to embodiments of the present invention are illustrated in FIGS. 4 and 5. The illustrated techniques are executed on a satellite system that includes memory-mapped network address. The technique of FIG. 4 may run during the setup of the system, while the technique of FIG. 5 may run when the identified memory changes. Furthermore, it should be assumed that the centralized application has already established a peer-to-peer connection to the satellite system, and has identified to the satellite system that the system memory is being used by the application.

In the illustrated embodiment of FIG. 4, the technique includes identifying to the system that there is memory to be cached, at 400. Moreover, the memory used for the memory-mapped network is identified at 402. A background task is then provided to monitor the memory, at 404.

In the illustrated embodiment of FIG. 5, the technique includes re-establishing a peer-to-peer connection, at 500. A CACHE DIRTY notification is then sent to the system, at 502.

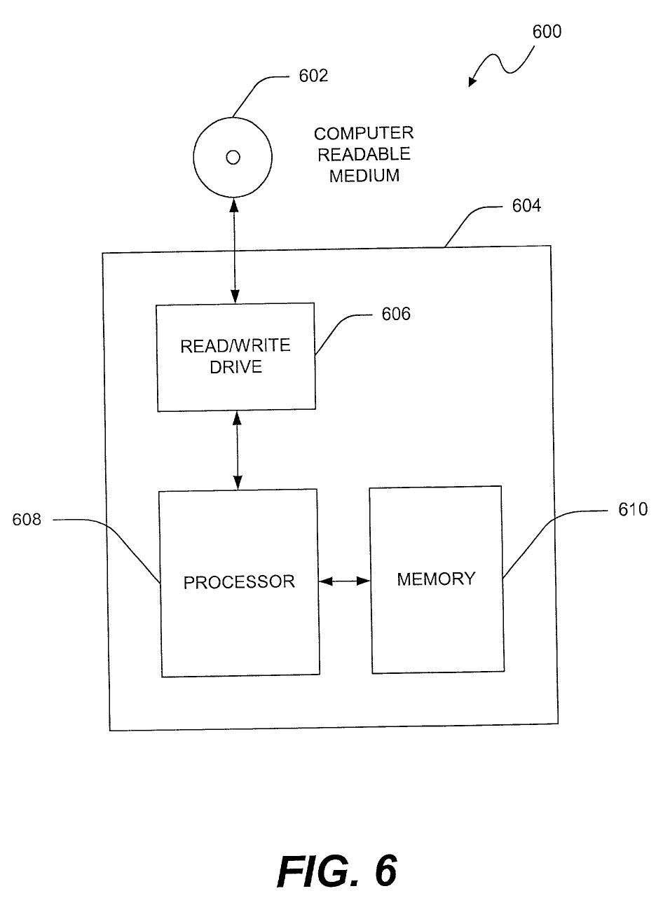

FIG. 6 is a block diagram of a processor-based system 600 which may execute codes residing on the computer readable medium 602. The codes are related to the techniques for caching data used in the distributed memory network described in FIGS. 3A through 5. In one embodiment, the computer readable medium 602 may be a fixed medium such as read-only memory (ROM) or a hard disk. In another embodiment, the medium 602 may be a removable medium such a floppy disk or a compact disk (CD). A read/write drive 606 in the computer 604 reads the code on the computer readable medium 602. The code is then executed in the processor 608. The processor 608 may access the computer memory 610 to store or retrieve data.

Illustrated embodiments of the system and technique for caching data, used in the distributed memory network described above in conjunction with FIGS. 1 through 6, present several advantages. The advantages of the network cache include enabling the distributed memory network to behave like a local memory system for time-critical response. Hence, without this capability to cache memory-mapped network data, applications using distributed memory may show significant performance degradation when compared to similar applications using only local memory. Moreover, this capability may also be useful for the storage of data when a satellite system goes offline. The local cache may enable the main application to continue to function. The data may be synchronized at a later time.

There has been disclosed herein embodiments for providing a memory-caching scheme in a distributed memory network. The disclosure includes a network-distributed memory mapping system that enables memory space expansion by memory mapping network address space into a local system memory design using a look-up table. Further, cache coherency in the distributed network may be maintained by utilizing a peer-to-peer connection, where satellite systems monitor the data being utilized by the centralized application. Specifically, a “cache dirty” notification may be provided through the peer-to-peer connection to alert the centralized application about stale data. The application may then wait to access the data until it is needed or immediately update depending on the network traffic and data need. Moreover, the application may also write directly to the cache and may continue to process while actual updating of the satellite systems may occur later.

While specific embodiments of the invention have been illustrated and described, such descriptions have been for purposes of illustration only and not by way of limitation. Accordingly, throughout this detailed description, for the purposes of explanation, numerous specific details were set forth in order to provide a thorough understanding of the present invention. It will be apparent, however, to one skilled in the art that the system and method may be practiced without some of these specific details. For example, although the illustrated embodiments have been described in terms of cache, other memory devices such as stacks or buffers may be used to provide a similar function. In other instances, well-known structures and functions were not described in elaborate detail in order to avoid obscuring the subject matter of the present invention. Accordingly, the scope and spirit of the invention should be judged in terms of the claims which follow.

What is claimed is:

1. A structure within a network, comprising:
a plurality of systems interconnected within the network, each system having a local memory;
a distributed memory to provide for use of the local memory in the distributed memory by enabling memory mapping of addresses of the plurality of systems to the distributed memory;
a network processor to control and execute the memory mapping of addresses; and
a cache to store data frequently used within the distributed memory but not stored in the local memory.

2. The structure of claim 1, further comprising:
a look-up table to enable memory mapping of system addresses by redirecting memory requests to the system addresses.

3. The structure of claim 1, wherein the local memory includes a non-volatile memory.

4. The structure of claim 1, wherein the plurality of systems includes computer systems.

5. The structure of claim 1, wherein the network includes the Internet.

6. The structure of claim 5, wherein the addresses of the plurality of systems include Internet Protocol (IP) addresses.

7. The structure of claim 6, wherein the IP addresses adhere to Internet Protocol Version 6 (IPv6).

8. The structure of claim 1, further comprising:
a network adapter to manage and provide the plurality of systems access to the network.

9. A method, comprising:
examining a message queue;
determining whether requested data is in a cache when the message queue indicates a data read;
determining whether the data in the cache is stale;
accessing the data from the cache if the data in the cache is not stale; and
accessing the data from a system network address if the data in the cache is stale.

10. The method of claim 9, further comprising:
accessing the data from the system network address if the requested data is not in the cache.

11. The method of claim 10, further comprising:
storing the accessed data into the cache.

12. The method of claim 11, further comprising:
updating to reflect a change in the cache.

13. The method of claim 9, wherein the determining whether the data in the cache is stale includes comparing contents of the cache with contents of memory in the system network address.

14. The method of claim 9, further comprising:
determining whether the data is being cached when the message queue indicates a data write;
writing the data to the cache if the data is being cached; and
setting up location in the cache for the data if the data is not being cached.

15. The method of claim 14, further comprising:
sending the data to the system network address.

16. The method of claim 9, further comprising:
asserting a data stale flag for the data from the system network address when the message queue indicates a cache stale notification.

17. The method of claim 9, further comprising:
accessing the data from the system network address when the message queue indicates a cache request.

18. The method of claim 17, further comprising:
storing the accessed data in the cache.

19. The method of claim 9, further comprising:
updating to reflect a change in the cache.

20. The method of claim 9, further comprising:
removing contents of the cache when the message queue indicates a cache clear.

21. The method of claim 20, further comprising:
updating to reflect a change in the cache.

22. The method of claim 9, further comprising:
identifying memory to be cached.

23. The method of claim 22, further comprising:
identifying memory to be used for memory mapping at the system network address.

24. The method of claim 23, further comprising:
providing a task to monitor the memory.

25. A computer readable medium containing executable instructions which, when executed in a processing system, causes the system to perform data caching in a distributed memory network, comprising:
examining a message queue;
determining whether requested data is in a cache when the message queue indicates a data read;
determining whether the data in the cache is stale;
accessing the data from the cache if the data in the cache is not stale; and
accessing the data from a system network address if the data in the cache is stale.

26. The medium of claim 25, further comprising:
accessing the data from the system network address if the requested data is not in the cache.

27. The medium of claim 26, further comprising:
storing the accessed data into the cache.

28. The medium of claim 27, further comprising:
updating to reflect a change in the cache.
